(19) United States
(12) Patent Application Publication
(10) Pub. No.: US 2004/0120088 A1
(43) Pub. Date: Jun. 24, 2004

(54) Intelligent electronic device protection circuit

(75) Inventors: Chang-Ching Twu, Yungho City (TW); Wei-Chiang Kao, Kaohsiung City (TW)

Correspondence Address: BACON & THOMAS, PLLC, 625 SLATERS LANE, FOURTH FLOOR, ALEXANDRIA, VA, 22314

(73) Assignee: ZONE TECHNOLOGY INC., Taipei (TW)

(21) Appl. No.: 10/327,049

(22) Filed: Dec. 24, 2002

(51) Int. Cl. H02H 3/00

(52) U.S. Cl. 361/59

(57) ABSTRACT

The invention is to provide a protection circuit comprising a monitoring circuit for sensing the toggled mode of a switch thereof and thus, when a user unexpectedly switches on or off the protection circuit, the monitoring circuit immediately senses a closed or opened signal indicating that the switch has been tripped ON or OFF and then forwards the signal to a control circuit to first terminate the connection between at least one electronic device and an external power supply, and then activate the control circuit to provide electrical power of a battery to the said electronic device and re-connect the external power supply to the electronic device after the electronic device is turned on or off, which achieves the objective of preventing current surges due to sudden switching the protection circuit that can directly damage the electronic device.

### BACKGROUND OF THE INVENTION

1) Field of the Invention

The invention herein relates to electrical current surge preventers, specifically an intelligent electronic device protection circuit.

2) Description of the Prior Art

Due to recent advances in electronics manufacturing and materials science, the successful development of new electronic components and production technology has not only lowered electronic product manufacturing costs, but also effectively improved the performance and quality of electronic products. Furthermore, as a result of continuous breakthroughs in semiconductor technology, conventional electronic components have been replaced by a range of various miniaturized semiconductor components that make possible electronic products that are significantly more lightweight and compact in response to market trends and demands, thereby greatly enhancing electronic product convenience and promoting their widespread use.

However, electronic devices now available are directly connected to external sources of electricity (such as indoor mains outlets) and their switches lack protective means such that when users abruptly switch them on, a momentary current surge from said external power sources occurs through the said switches that rapidly ingress the internal circuitry of the said electronic devices and seriously damages the said circuitry, resulting in the impairment and abnormal operation of the said circuitry.

### SUMMARY OF THE INVENTION

An objective of the invention herein is to provide a protection circuit, the said protection circuit having a control circuit, the said control circuit respectively connected to a switch, a monitoring circuit, a battery, and an electronic device, wherein the said switch is connected to an external power supply, the said monitoring circuit is connected to the said switch, the said external power supply furnishes the electrical power as required to the said electronic device(s), enabling the operation of the said electronic device(s), and the said monitoring circuit senses the toggled mode of the said switch and thus, when the user unexpectedly switches on the said protection circuit, the said monitoring circuit immediately senses a closed signal indicating that the said switch has been tripped ON and forwards the said closed signal to the said control circuit, causing the said control circuit to first terminate the connection between the said electronic device(s) and the said external power supply, and then activate the said control circuit to provide electrical power of the said battery to the said electronic device(s) and re-connect the said external power supply to the said electronic device(s) after the said electronic device(s) being turned on by the said control circuit, which achieves the objective of preventing current surges due to sudden switching on the said protection circuit that can directly damage the said electronic device(s).

Another objective of the invention herein is that when the user unexpectedly switches off the said protection circuit, the said monitoring circuit immediately senses a opened signal indicating that the said switch has been tripped OFF and forwards the said opened signal to the said control circuit, causing the said control circuit to first terminate the connection between the said electronic device(s), and then activate the said control circuit to provide electrical power of the said battery to the said electronic device(s) and re-connect the said external power supply to the said electronic device(s) after the said electronic device(s) being turned off by the said control circuit, thereby achieving the objective of protecting the said electronic device(s) by averting damage to the said electronic device(s) due to abnormal switching off the said protection circuit.

The above and other objects, features and advantages of the present invention will become apparent from the following detailed description taken with the accompanying drawings.

### BRIEF DESCRIPTION OF THE DRAWINGS

FIG. 1 is a block diagram of the invention herein.

FIG. 2 is a schematic drawing of the monitoring circuit of the invention herein.

FIG. 3 is a schematic drawing of the battery charging circuit of the invention herein.

FIG. 4 is a schematic drawing of the control circuit of the invention herein (1).

FIG. 5 is a schematic drawing of the control circuit of the invention herein (2).

FIG. 6 is a schematic drawing of the control circuit of the invention herein (3).

FIG. 7 is a block diagram of an embodiment of the invention herein.

### DETAILED DESCRIPTION OF THE INVENTION

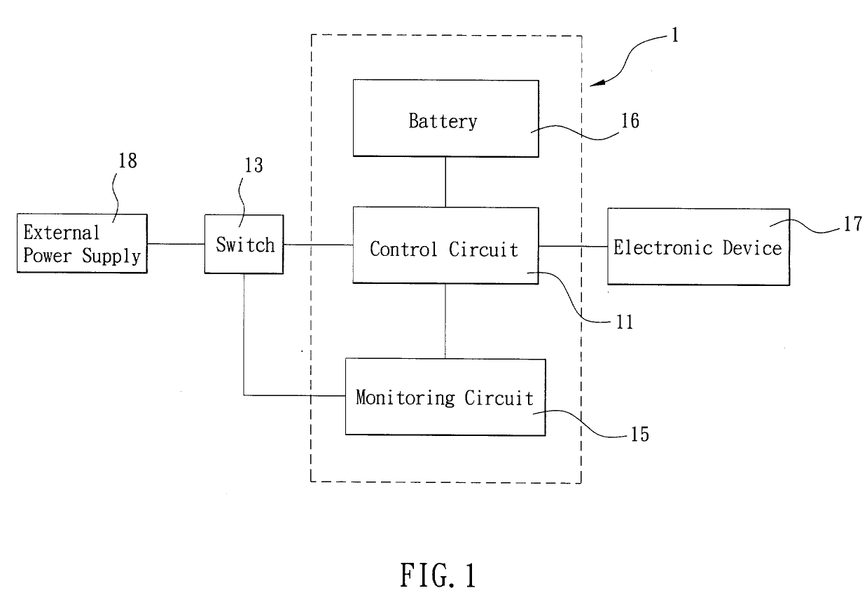

The invention herein is an intelligent electronic device protection circuit, referring to FIG. 1, comprised of a protection circuit 1, the said protection circuit 1 shunted between a switch 13 and an electronic device(s) 17 and utilized to protect the electronic device(s) 17 when the said switch 13 is tripped ON and OFF, with the said protection circuit 1 having a control circuit 11, a monitoring circuit 15, and a battery 16, wherein the control circuit 11 is respectively connected to the said switch 13, the said monitoring circuit 15, the said battery 16, and the said electronic device(s) 17, the said switch 13 also connected to an external power supply 18 and, furthermore, the said monitoring circuit 15 is connected to the said switch 13 and the said control circuit 11 for sensing the toggled mode of the said switch 13 and activating the said control circuit 11 to provide the electrical power of the said battery 16 or the said external power supply 18 to the said electronic device(s) 17.

Given the said structural arrangement, when the user unexpectedly switches on the said protection circuit 1, the said monitoring circuit 15 immediately senses a closed signal indicating that the said switch 13 has been tripped ON and the said closed signal is forwarded to the said control circuit 11, causing the said control circuit 11 to first terminate the connection between the said electronic device(s) 17 and the said external power supply 18, and then activate the said control circuit 11 to provide the electrical power of the said battery 16 to the said electronic device(s) 17 and re-connect the said external power supply 18 to the said electronic device(s) 17 after the said electronic device(s) 17 is turned on by the said control circuit 11.

When the user unexpectedly switches off the said protection circuit 1, the said monitoring circuit 15 immediately senses an opened signal indicating that the said switch 13 has been tripped OFF and forwards the said opened signal to the said control circuit 11, causing the said control circuit 11 to first terminate the connection between the said electronic device(s) 17 and the said external power supply 18, and then activate the said control circuit 11 to provide the electrical power of the said battery 16 to the said electronic device(s) 17 and re-connect the said external power supply 18 to the said electronic device(s) 17 after the said electronic device(s) 17 is turned off by the said control circuit 11.

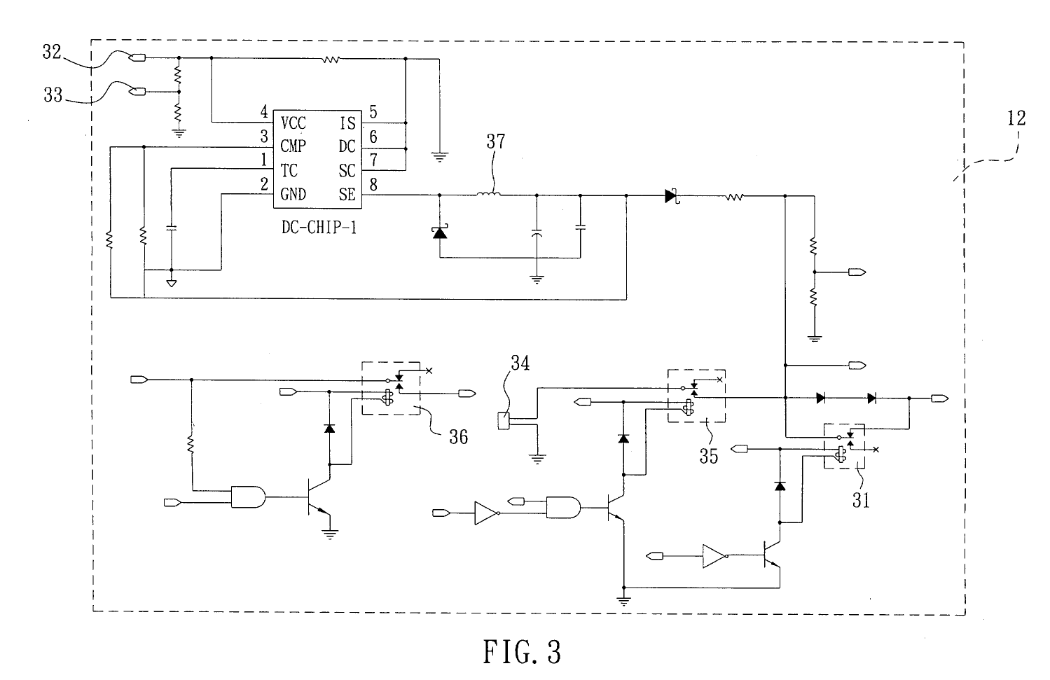

In the invention herein, referring to FIG. 1 and FIG. 3, the said battery 16 is a rechargeable unit; when the said control circuit 11 senses that the said battery 16 is insufficiently charged, the said control circuit 11 manages the connection of the said external power supply 18 to the battery charging circuit 12 of the said control circuit 11 (as shown in FIG. 3) such that the said external power supply 18 furnishes electric power to the said battery charging circuit 12, enabling the battery charging circuit 12 to charge the said battery 16 and, furthermore, when the said control circuit 11 senses that the said battery 16 is fully charged, the said control circuit 11 terminates the connection between the said external power supply 18 and the said battery charging circuit 12 to stop the charging of the said battery 16.

In the invention herein, referring again to FIG. 1, the said battery 16 can be a lithium battery.

In the invention herein, referring again to FIG. 1, the said monitoring circuit 15 can be equipped with a manually operated switch (not shown in the drawings), enabling the user to toggle the closed state of the said manually operated switch and thereby stop the said monitoring circuit 15 from sensing the said switch 13.

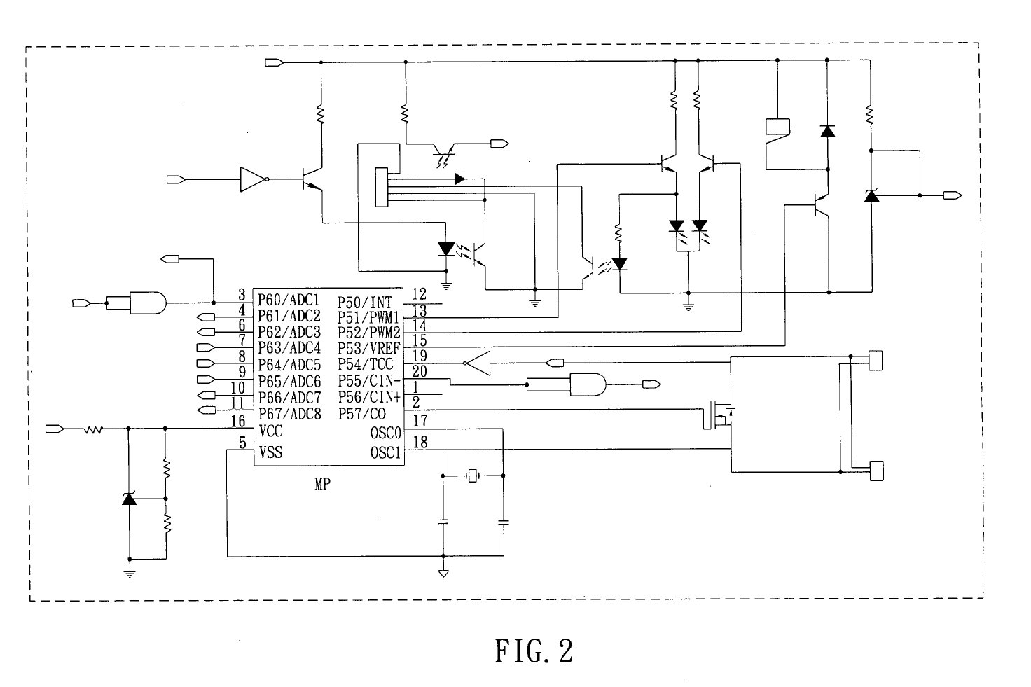

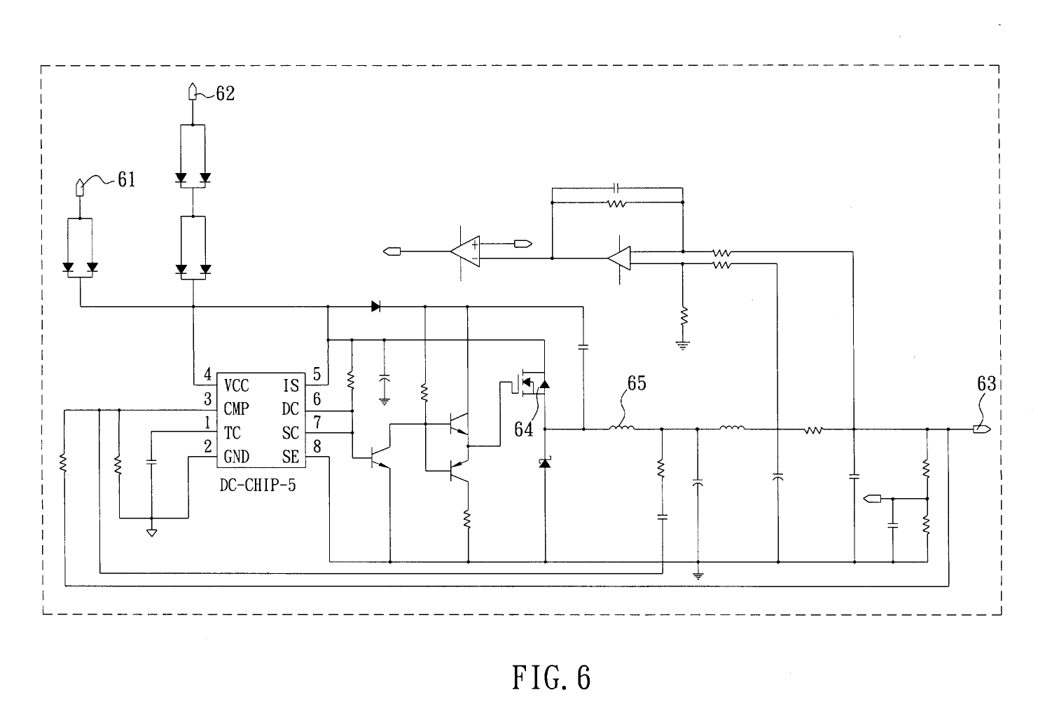

In the most preferred embodiment of the invention herein, referring to FIG. 1 and FIG. 2, the control circuit drawings of the present invention, the said circuit has a model EM78P458/9 specification, programmable controller chip MP and the pins 9 of the said chip MP are connected to the said switch 13; referring to FIG. 6, the drawing of another control circuit embodiment of the invention herein, a contact 61 is connected to the said switch 13, a contact 62 is connected to the said battery 16, and a contact 63 serving as an output end is connected to the said electronic device(s) 17, thereby interconnecting the said battery 16 and the said switch 13.

When pin 9 senses the closed signal indicating that the said switch 13 has been tripped, the said chip MP performs a five-second count and then re-scans the said switch 13; if a closed signal is detected, then pin 2 issues an OFF signal to the said electronic device(s) 17, at which time since the said battery 16 and said switch 13 are connected, the said switch 13 is immediately closed and the battery 16 provides electric power to the said electronic device(s) 17, enabling the said electronic device(s) 17 to utilize the said electric power to execute a switch off and then issue a signal to pin 8 of the said chip MP after switching off is completed, thereby closing the starter switch 31 (as shown in FIG. 3) at pin 1 of the said chip MP and terminating the said battery 16 and connecting to the said electronic device(s) 17.

When pin 9 senses the closed signal indicating that the said switch 13 has been tripped, the said chip MP performs a five-second count and then re-scans the said switch 13; if a closed signal is detected, then pin 2 issues an ON signal to the said electronic device(s) 17, and the battery 16 provides electric power to the said electronic device(s) 17, enabling the said electronic device(s) 17 to utilize the said electric power to execute a switch on and then issue a signal to pin 8 of the said chip MP after switching on is completed, thereby opening the starter switch 31 (as shown in FIG. 3) at lead 1 of the said chip MP and connecting the said external power supply 18 to the said electronic device(s) 17.

In the said embodiment, referring to FIG. 2 and FIG. 3, the schematic drawing of the battery 12 charging circuit of the invention herein, a contact 32 is connected to the said switch 13, a contact 33 is connected to pin 9 of the chip MP, and a contact 34 is connected to the said battery 16 ( a rechargeable battery); pin 9 reads the voltage of the battery 16 and when the voltage of the battery 16 drops below a certain working level, pin 2 closes the starter switch 35, enabling the external power supply 18 to charge the said battery 16 via the said switch 13. When pin 9 ascertains that the said battery 16 is fully charged, i.e., the voltage of the said battery 16 has increased to a certain working level, the said pin 2 opens the starter switch 35 to terminate battery charging.

In the said embodiment, referring to FIG. 2 and FIG. 3, the said battery charging circuit 12 has a voltage reduction control circuit consisting of a model P2K22010C specification, chip DC-CHIP-1 that controls the said voltage reduction routine by lowering the output of the external power supply 18 down to a charging voltage; when pin 4 reads that the output of the external power supply 18 is higher than the charging voltage, pin 8 opens a switch 36 that diverts a portion of voltage to a capacitor 37, thereby reducing external power supply 18 output to the charging voltage.

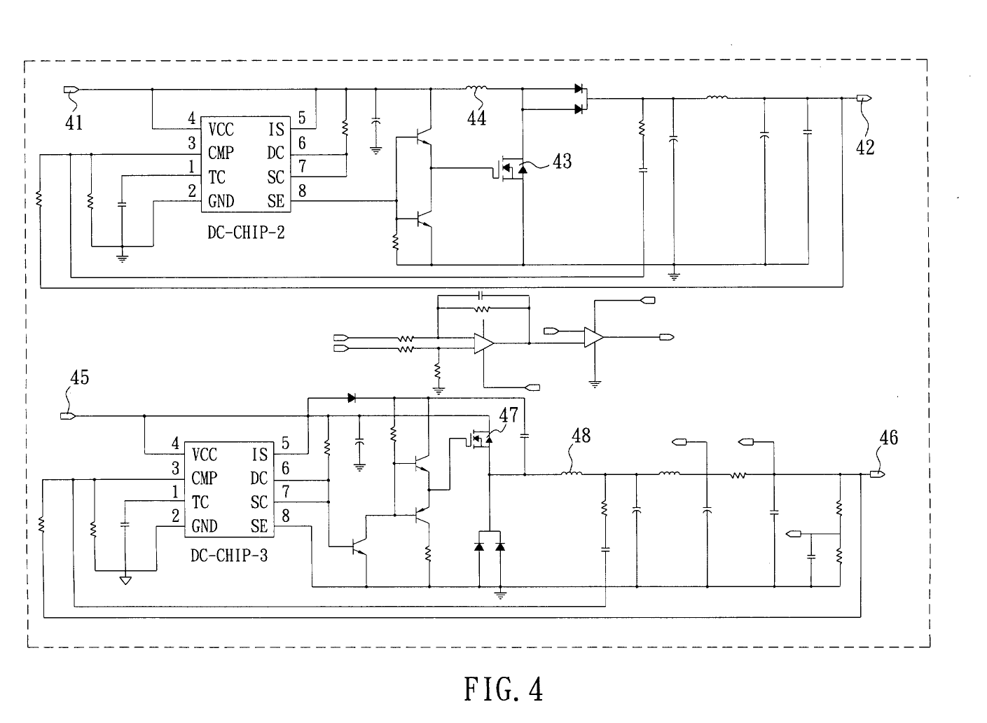

In the said embodiment, referring to FIG. 2 and FIG. 4, the schematic drawing of the voltage reduction control circuit of the invention herein, a model P2K22010C specification, chip DC-CHIP-2 controls said voltage reduction routine, wherein a contact 41 is connected to the said switch 13 and the output end of a contact 42 is connected to the said electronic device(s) 17; since the working voltage of each electronic device 17 is different (such as 12V and 5V, etc.), the said contact 42 provides the required working voltage to each electronic device 17; when pin 4 reads that the switch 13 input of the external power supply 18 is higher than the working voltage, pin 8 opens a switch 43, and portion of the voltage is diverted to a capacitor 44, thereby reducing external power supply 18 output to the working voltage.

In the said embodiment, referring again to FIG. 2 and FIG. 4, the schematic drawing of the voltage reduction control circuit of the invention herein, a model P2K22010C specification, a chip DC-CHIP-3 controls said voltage reduction routine and comprises a another voltage reduction control circuit, wherein a contact 45 is connected to the said switch 13 and the output end of a contact 46 is connected to the said electronic device(s) 17; since the working voltage of each electronic device 17 is different (such as 12V and 5V, etc.), the said contact 46 provides the required working voltage to each electronic device 17; when pin 4 reads that the switch 13 input of the external power supply 18 is higher than the working voltage, pin 8 opens a switch 47, and a portion of the voltage is diverted to a capacitor 48, thereby reducing external power supply 18 output to the working voltage.

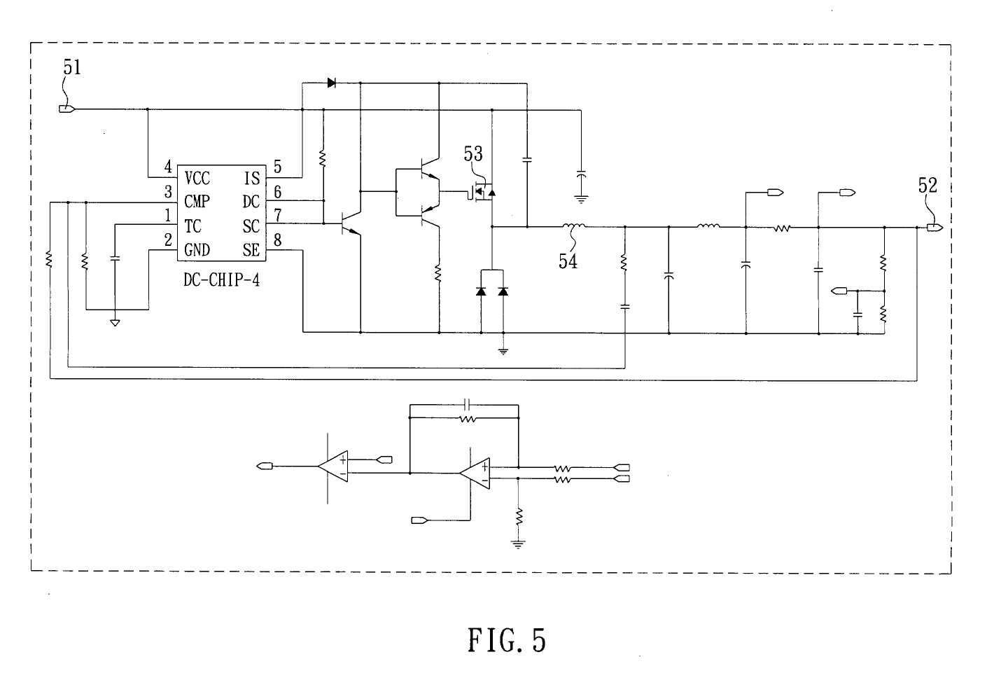

In the said embodiment, referring again to FIG. 2 and FIG. 5, the schematic drawing of the voltage reduction control circuit of the invention herein, a model P2K22010C specification, a chip DC-CHIP-4 controls said voltage reduction routine and comprises a another voltage reduction control circuit, wherein a contact 51 is connected to the said switch 13 and the output end of a contact 52 is connected to the said electronic device(s) 17; since the working voltage of each electronic device 17 is different (such as 12V and 5V, etc.), the said contact 52 provides the required working voltage to each electronic device 17; when pin 4 reads that the switch 13 input of the external power supply 18 is higher than the working voltage, pin 8 opens a switch 53, and a portion of the voltage is diverted to a capacitor 54, thereby reducing external power supply 18 output to the working voltage.

In the said embodiment, referring again to FIG. 2 and FIG. 6, the schematic drawing of the voltage reduction control circuit of the invention herein, a model P2K22010C specification, a chip DC-CHIP-5 controls said voltage reduction routine; when pin 4 reads that the output of the battery 16 or the external power supply 18 is higher than the working voltage, pins 6 and 7 open a switch 64, and a portion of the voltage is diverted to a capacitor 65, thereby reducing external power supply 18 or battery 16 output to the working voltage of the electronic device(s) 17.

As such, since the invention herein protects the said electronic device(s) 17 by preventing current surges resulting from sudden switching that can directly damage the said electronic device(s) 17, while also safeguarding the said electronic device(s) 17 by averting damage to the said electronic device(s) 17 due to abnormal user switching, the present invention is an advantageous innovation.

The title, parts number, specification and model of the device(s) showed in the said embodiments:

| Specification | | | |
|---|---|---|---|
| and Model | Title | Parts Number | Supplier |
| EM78P458/9 | Programmable Control Chip | MP | EMC |
| P2K22010C | PWM | DC-CHIP-1 | |
| P2K22010C | PWM | DC-CHIP-2 | |
| P2K22010C | PWM | DC-CHIP-3 | |
| P2K22010C | PWM | DC-CHIP-4 | |
| P2K22010C | PWM | DC-CHIP-5 | |

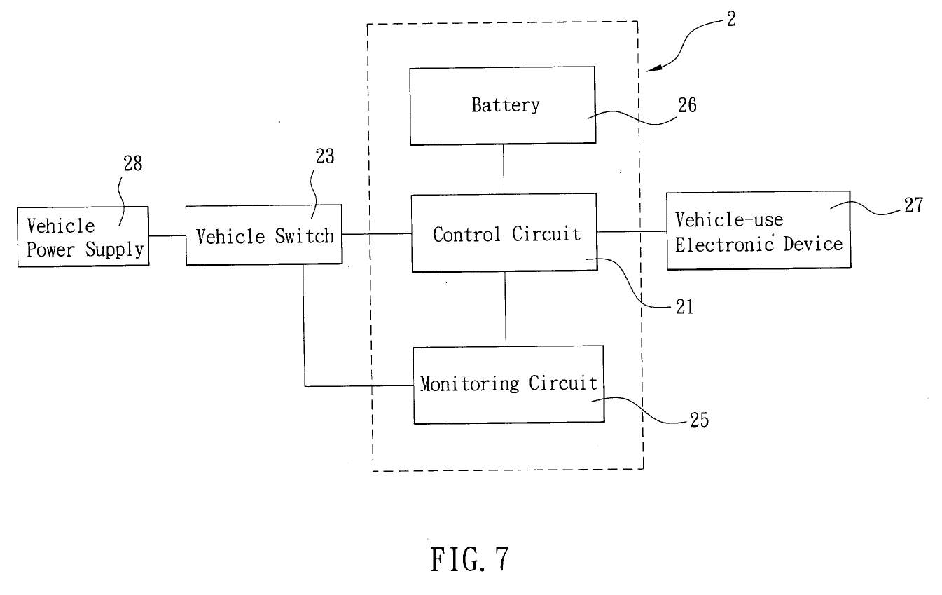

In the invention herein, the said protection circuit can be installed in a vehicle, a ship, a sound system, or other electronic product; another preferred embodiment of the invention herein is utilized in a vehicle, referring to FIG. 7, the said protection circuit 2 consists of a control circuit 21, a monitoring circuit 25, and a battery 26, wherein the said control circuit 21 is respectively connected to a vehicle switch 23, the said monitoring circuit 25, the said battery 26, and a minimum of one vehicle-use electronic device 27 (such as a portable computer, a mobile telephone, and a VCD, etc.); the said vehicle switch 23 is connected to a vehicle power supply 28 (a battery or an alternator) and, furthermore, the said monitoring circuit 25 is connected to the said vehicle switch 23 and thus, when the user unexpectedly closes the vehicle switch, the said monitoring circuit 25 immediately senses an opened signal indicating that the said vehicle switch 23 has been tripped OFF and forwards the said opened signal to the said control circuit 21, causing the said control circuit 21 to first terminate the connection between the said electronic device 27 and the said vehicle power supply 28, then activate the said control circuit 21 to provide the electrical power of the said battery 26 to the said electronic device(s) 27 and re-connect the said vehicle power supply 28 to the said electronic device(s) 27 after the said electronic device(s) 27 is turned off by the said control circuit 21.

Additionally, when the user unexpectedly starts the vehicle, the said monitoring circuit 25 immediately senses a closed signal indicating that the said vehicle switch 23 has been tripped ON and forwards the said closed signal to the said control circuit 21, causing the said control circuit 21 to first terminate the connection between the said electronic device 27 and the said vehicle power supply 28, then activate the said control circuit 21 to provide the electrical power of the said battery 26 to the said electronic device(s) 27 and re-connect the said vehicle power supply 28 to the said electronic device(s) 27 after the said electronic device(s) 27 is turned on by the said control circuit 21.

In the said embodiment, referring again to FIG. 3 and FIG. 7, the said battery 26 is a rechargeable unit; when the said control circuit 21 senses that the said battery 26 is insufficiently charged, the said control circuit 21 administers the connection of the said vehicle power supply 28 to the battery charging circuit 12 of the said control circuit 21 (as shown in FIG. 3) such that the said external power supply 28 furnishes electric power to the said battery charging circuit 12, enabling the battery charging circuit 12 to charge the said battery 26 and, furthermore, when the said control circuit 21 senses that the said battery 26 is fully charged, the said control circuit 21 terminates the connection between the said vehicle power supply 28 and the said battery charging circuit 12 to stop the charging of the said battery 26.

In the said embodiment, referring again to FIG. 7, the said battery 26 can be a lithium battery.

In the said embodiment, referring again to FIG. 7, the said control circuit 21 can be an automotive computer installed in the vehicle.

In the said embodiment, referring again to FIG. 7, the said monitoring circuit 25 can be equipped with a manually operated switch (not shown in the drawings), enabling the user to toggle the closed state of the said manually operated switch and thereby stop the said monitoring circuit 25 from sensing the said vehicle switch 23.

As such, since the invention herein protects the said electronic device(s) 27 by preventing current surges resulting from sudden switching that can directly damage the said electronic device(s) 27, while also safeguarding the said electronic device(s) 27 by averting damage to the said electronic device(s) 27 due to abnomal user switching, the present invention is an advantageous innovation.

While the invention has been described by means of specific embodiments, numerous modifications and variations could be made thereto by those skilled in the art without departing from the scope and spirit of the invention set forth in the claims.

1. An intelligent electronic device protection circuit, wherein a protection circuit is shunted between a switch and at least one electronic device and utilized to protect the said electronic device when the said switch is tripped, and which is comprised of:
a control circuit respectively connected to the said switch and the said electronic device, with the said switch also connected to an external power supply for furnishing electrical power to the electronic device;
a monitoring circuit respectively connected to the said switch and the said control circuit for activating the said control circuit according the toggled mode of the said switch being sensed;
a battery connected to the said control circuit for providing electrical power to the electronic device through the control of the said control circuit;
when the said protection circuit being unexpectedly switched on or off, the said monitoring circuit immediately senses a closed or opened signal indicating that the said switch has been tripped ON or OFF and forwards the said closed or opened signal to the said control circuit, causing the said control circuit to first terminate the connection between the said electronic device and the said external power supply, and then activate the said control circuit to provide electrical power of the said battery to the said electronic device and re-connect the said external power supply to the said electronic device after the said electronic device is turned on or off.

2. An intelligent electronic device protection circuit as claimed in claim 1 in which the said battery is a rechargeable unit; when the said control circuit senses that the said battery is insufficiently charged, the said control circuit manages the connection of the said external power supply to the battery charging circuit of the said control circuit such that the said external power supply furnishes electric power to the said battery charging circuit, enabling the said battery charging circuit to charge the said battery and, furthermore, when the said control circuit senses that the said battery is filly charged, the said control circuit terminates the connection between the said external power supply and the said battery charging circuit to stop the charging of the said battery.

3. An intelligent electronic device protection circuit as claimed in claim 1 in which the said monitoring circuit can be equipped with a manually operated switch, enabling the user to toggle the closed state of the said manually operated switch and thereby stop the said monitoring circuit from sensing the said switch.

4. An intelligent electronic device protection circuit as claimed in claim 1 in which the said battery can be a lithium battery.
